(19) United States
(12) Patent Application Publication
(10) Pub. No.: US 2006/0284861 A1
(43) Pub. Date: Dec. 21, 2006

(54) Display apparatus and control method thereof

(75) Inventor: Jin-su Choi, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/370,804

(22) Filed: Mar. 9, 2006

(30) Foreign Application Priority Data
Jun. 20, 2005 (KR) 10-2005-0052981

(51) Int. Cl. G09G 5/00

(52) U.S. Cl. 345/204

(57) ABSTRACT

A display apparatus and method is provided having a display part for receiving an image signal from the outside and displaying an image, comprising a user window generator for generating a history window comprising at least one display parameter for determining a display state of the image displayed in the display part, and at least one history of prechanged values corresponding to the display parameters, and a controller for controlling the user window generator so that the history window is displayed in the display part by receiving a control signal for changing the display parameter. Thus, the display apparatus and control method can be used for facilely adjusting a plurality of display parameters using changed and prechanged values discernable from a history window and which determine a display state of a displayed image.

### CROSS-REFERENCE TO RELATED APPLICATIONS

This application claims the benefit under 35 U.S.C. §119(a) of Korean Patent Application No. 10-2005-0052981, entitled “Display Apparatus and Control Method Thereof,” filed in the Korean Intellectual Property Office on Jun. 20, 2005, the entire disclosure of which is hereby incorporated by reference.

### BACKGROUND OF INVENTION

1. Field of Invention

The present invention relates to a display apparatus and a control method thereof. More particularly, the present invention relates to a display apparatus and a control method thereof that is capable of adjusting parameters for setting up a display state of a displayed image.

2. Description of the Related Art

Conventionally, a display apparatus is a device that displays an image by receiving an image signal such as Horizontal/Vertical Sync signals, R (Red) image signals, G (Green) image signals, B (Blue) image signals, and the like. The display apparatus may supply information about display parameters which determine a state of a displayed image, and generally, it may be displayed in an On Screen Display (OSD) window.

The user realizes the optimal image display state according to the user's taste by selecting and changing the display parameters displayed in the OSD window. When the user changes and stores such a display parameter several times, such as in the case where a desired window is not set up, or when the user wants the former changed window, the user is required to memorize the changed information. Unless the user memorizes the information, it is impossible to find the desired changed information, and it takes a large degree of effort and time to get the desired changed information.

Further, the user is required to set up all display parameters from an initial step because the user does not know the information of the former display parameters in the case where the display parameters are changed by another person.

Accordingly, a need exists for a system and method for effectively and efficiently adjusting and retrieving a plurality of display parameters which determine a display state of a displayed image.

### SUMMARY OF THE INVENTION

Accordingly, embodiments of the present invention are provided to substantially solve the above and other problems, and provide a display apparatus and a control method to facilely adjust a plurality of display parameters which determine a display state of a displayed image.

The foregoing and other objects of embodiments of the present invention are substantially realized by providing a display apparatus having a display part for receiving an image signal from the outside and displaying an image, the apparatus comprising a user window generator for generating a history window comprising at least one display parameter for determining a display state of the image displayed in the display part, and at least one history of a prechanged value corresponding to the display parameters, and a controller for controlling the user window generator so that the history window is displayed in the display part by receiving a control signal for changing the display parameter.

The display apparatus further comprises a memory for storing the display parameter and the history, wherein the controller controls the display part to display the image according to the history corresponding to the display parameter stored in the memory if at least one display parameter is selected in the history window, and controls the memory to store the adjusted display parameter and the history.

The history with respect to the prechanged display parameter is displayed in the history window in time sequential order.

The history comprises at least one of a changed value and a changed date.

The controller controls the display part to display a test window, on which the image is displayed according to the history corresponding to the display parameter stored in the memory, if the display parameter in the history window is selected.

The controller further controls the memory to store the display parameter and the history corresponding to the display parameter if the controller determines that the test window is proper.

The user window generator further generates a menu window with respect to the plurality of display parameters which determine the display state of the image displayed in the display part. The menu window comprises a history selection item for displaying the history window.

The display parameters comprise at least one of a position parameter, a color temperature parameter, a resolution parameter, clock and phase parameters, a contrast parameter, a brightness parameter, and an audio parameter, but are not limited thereto.

The user window generator comprises an OSD generator, but is not limited thereto.

The foregoing and other objects of embodiments of the present invention are also substantially realized by providing a control method of a display apparatus having a display part for receiving an image signal from the outside and displaying an image, wherein the method comprises generating a history window comprising at least one display parameter for determining a display state of the image displayed in the display part according to a control signal and at least one history of a prechanged value corresponding to the display parameter, displaying the image according to the history corresponding to the stored display parameter if at least one display parameter is selected in the history window, displaying a test window on which the image is displayed according to the adjusted history, determining properties of the test window, and storing the display parameter and the history corresponding to the display parameter in the case where the test window is proper.

Other objects, advantages, and salient features of embodiments of the present invention will become apparent from the detailed description, which, taken in conjunction with the annexed drawings, discloses exemplary embodiments of the present invention.

### BRIEF DESCRIPTION OF THE DRAWINGS

These and other aspects, features, and advantages of exemplary embodiments of the present invention will become more apparent and more readily appreciated from the following detailed description, taken with reference to the accompanying drawings, in which:

FIG. 1 is a control block diagram of a display apparatus in accordance with an embodiment of the present invention;

FIG. 2 illustrates a history window in accordance with an embodiment of the present invention; and

FIG. 3 is a control flow diagram of a display apparatus in accordance with an embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as detailed construction and elements thereof, are provided to assist in a comprehensive understanding of embodiments of the present invention and are merely exemplary. Accordingly, those of ordinary skill in the art will recognize that various changes and modifications of embodiments of the present invention described herein can be made without departing from the scope and spirit of the present invention.

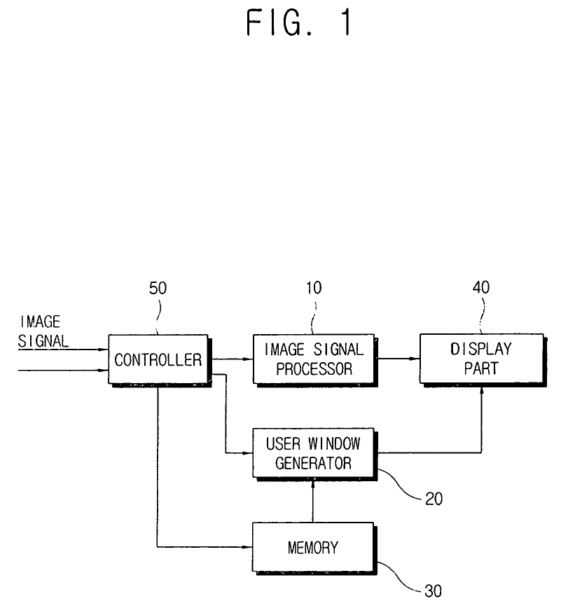

FIG. 1 is a control block diagram of a display apparatus in accordance with an embodiment of the present invention. As shown therein, the display apparatus comprises an image signal processor 10, a user window generator 20, a memory 30, a display part 40, and a controller 50 for controlling the foregoing elements.

The image signal processor 10 processes an image signal, which is input from the outside by control of the controller 50, to display in the display part 40. The image signal generally comprises an image signal to be input through a video player or a DVD player, a standard definition (SD) image signal, or a high definition (HD) image signal, but is not limited thereto. The image signal processor 10 comprises blocks (not shown) for processing the image signal, such as an A/D converting block for converting an analog signal into a digital signal, a decoding block for decoding the image signal in an encoding state, and a block for changing the encoded image signal into a predetermined format such as for a predetermined resolution and color. The image signal processor 10 processes the input image signal into a predetermined format which can then be displayed.

The user window generator 20 generates a menu window, which serves as a user interface window with respect to a plurality of display parameters for determining the display state of the image, and a history window which comprises at least one prechanged history value corresponding to the plurality of display parameters.

The display parameters denote items which can determine the display state of the image displayed in the display part 40, and comprise a position parameter, a color temperature parameter, a resolution parameter, clock and phase parameters, a contrast parameter, and a brightness parameter, but are not limited thereto. The position parameter determines a position of a display region on the display part 40, and the color temperature parameter controls the color sense of the image. An R (Red) color gives a warm sense and is controlled by increasing the color temperature parameter of the R color. A B (Blue) color gives a cool sense and is controlled by increasing the color temperature parameter of the B color. A moderate color is generated by properly controlling the R color and the B color. The resolution parameter selects any one of a Video Graphics Array (VGA), a Super VGA (SVGA), an Extended Graphics Array (XGA), a Video XGA (VXGA), a Super XGA (SXGA), and a Ultra XGA (UXGA), and the clock and phase parameters control the clock and the phase of the image so as to satisfy a predetermined condition of the display part 40 when the external image signal is input. The contrast and brightness parameters control a shadow and a brightness of the image displayed on the display part 40.

The display apparatus supplies a predetermined user interface so that the user can select and change various display parameters, and the menu window is provided as one such user interface. The user can change and store the display parameters according to the user's taste by using the menu window. In the case where a display parameter is changed, the image to be adjusted by the changed display parameter is displayed in the display part 40.

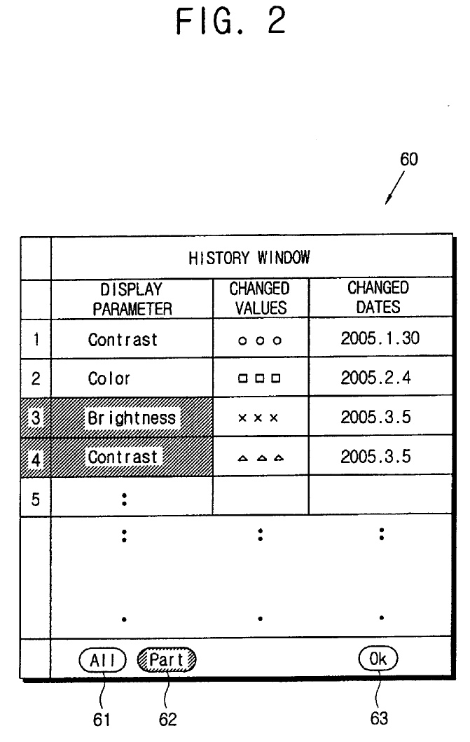

As shown in FIG. 2, an exemplary history window displays the display parameters and the history of the prechanged display parameters corresponding thereto, and supplies the changed information with respect to the display parameters to the user. The history information corresponding to the display parameters denotes changed values and changed dates in the case where the user changes the plurality of display parameters by using the menu window. The history window 60 shows the history information in time sequential order. As shown therein, the contrast displayed in a first item has been changed in a predetermined value on Jan. 30, 2005, and it has again been changed on Mar. 5, 2005. Between these dates, the color and the brightness have been changed on Feb. 4, 2005, and on Mar. 5, 2005, respectively. The changed values may be shown in numerical values, or as the image of a circle or bar shape, but is not limited thereto.

A conventional user window does not supply the history information of the display parameters, which have already changed, as one whole window. Therefore, the user is not able to selectively apply the former information which has already been changed. When the display apparatus according to embodiments of the present invention supplies such a history window 60 to the user, the user can refer to the history information shown in the history window 60, and then apply the prechanged display parameters. The history window 60 further comprises buttons 61, 62, and 63, which can be used to select all or less than all items, as well as the display parameters and the history corresponding thereto.

If all display parameters to be prechanged are selected by an all selection button (ALL) 61, all values with respect to present display parameters are changed to values of former display parameters. If the same display parameter is changed two or more times, the value of the display parameter may be changed to the latest value to be changed or the optimal values which the user has already setup.

As shown therein, if the brightness parameter and the contrast parameter, respectively displayed in the third item and the fourth item, are selected by a part selection button 62, the values of the brightness parameter and the contrast parameter are reset to the values which the user has already changed. As noted above, the display parameter which has already been changed, can be renewed to the present display parameter, so that the user can more simply and facilely adjust the display environment.

In another embodiment of the present invention, the history window 60 may comprise a window which illustrates each history corresponding to a respective display parameter, or may comprise a serve window which displays them as one item in the case where the plurality of display parameters are changed together, and then supplies detailed information on the case when one item is selected.

An OK button 63 executes a test window which displays the adjusted image according to the selected display parameter, in the case where the display parameter is selected by the all selection button 61 and the part selection button 62. When the test window is displayed, the user determines if the desired image is displayed, and then selects an application of the selected display.

Such a history window 60 may be displayed in the display part 40 by the control signal input from the user, or displayed through the menu window. That is, embodiments of the present invention further comprise a history selection item for displaying the history window 60 in the menu window.

Returning to FIG. 1, the user window generator 20 according to an exemplary embodiment of the present invention serves as an OSD generator provided in the display apparatus to be controlled. In yet another exemplary embodiment of the present invention, the menu window may be a window displayed by control of a computer main body (not shown) connected to the display apparatus through the interface part. In this case, the menu window is generated and controlled by programs stored in the computer main body.

The memory 30 stores the display parameter and the history corresponding thereto by the control of the controller 50. The memory 30 upgrades the display parameter preferably every time the user changes the display parameter. The display apparatus then stores all changed information in a predetermined range, but does not store only new information by deleting the former information, because the information of the changed display parameter should preferably be supplied in time sequential order. The user may set up the number of the prechanged display parameters which the memory 30 can store, and the number of the display parameters which the user can select. The user may ensure more stored change information with respect to the display parameter which the user can enable to select by providing additional memory.

The display part 40 displays the processed image from the image signal processor 10, and the menu window or the history window which are generated in the user window generator 20.

The controller 50 controls the image, according to the image signal received from the outside, that is output to the display part 40, and controls the user window generator 20 so as to generate the display parameters for determining the display state of the image displayed in the display part 40, and the history window displaying the prechanged history corresponding thereto. The controller 50 generates the test window on which the image is displayed according to the display parameter stored in the memory 30 if at least one display parameter in the history window 60 is selected. The user may then determine an application of the selected display parameter through the test window. In the case where the controller 50 determines that the test window is proper, the controller 50 controls the memory 30 to store the selected display parameter and the history corresponding thereto to be displayed with the image.

The display apparatus further comprises a key input part (not shown) or a remote controller (not shown) for inputting the control signal to the display apparatus for generating the menu window and the history window 60, and the signal for changing the display parameter.

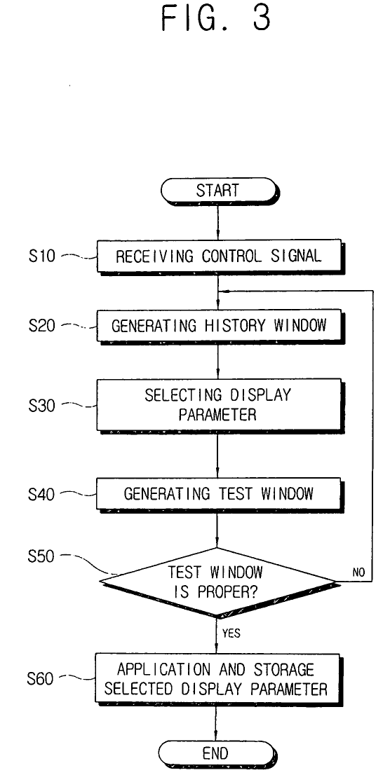

FIG. 3 is a control flow diagram of a display apparatus in accordance with an embodiment of the present invention.

At operation S10, the controller 50 receives the control signal, and at operation S20, the controller 50 generates the history window 60. The history window 60 may be generated by the history selection item after generating the menu window.

At operation S30, the plurality of prechanged display parameters being displayed in the history window 60 are selected. All or less than all of the display parameters may be selected, and/or the plurality of discontinuous display parameters may be selected. At operation S40, the controller 50 generates the test window on which the image is displayed according to the selected display parameter.

At operation S50, the user determines whether the selected display parameter is proper through the test window, and at operation S60, in the case where the test window is proper, the user applies the selected display parameter and then stores it.

In the case where the test window is not proper, the user may select a changed display parameter by again generating the history window 60. Further, the user may set up new display parameters by generating the menu window.

Therefore, the user can simply and facilely use the display parameters which have already been set up, by generating the history window 60.

While the present invention has been shown and described with reference to certain exemplary embodiments thereof, it will be understood by those skilled in the art that various changes in form and detail may be made therein without departing from the spirit and scope of the invention as defined by the appended claims and their equivalents.

What is claimed is:

1. A display apparatus having a display part for receiving an image signal and displaying an image, comprising:
a user window generator for generating a history window comprising at least one display parameter for determining a display state of an image displayed in the display part, and at least one history of a prechanged value corresponding to the display parameter; and
a controller for controlling the user window generator so that the history window is displayed in the display part by receiving a control signal for changing the display parameter.

2. The display apparatus according to claim 1, further comprising:
a memory, for storing at least one of the display parameter and the history, wherein the controller controls the display part to display the image according to the history corresponding to the display parameter stored in the memory if at least one display parameter is selected in the history window, and controls the memory to store the adjusted display parameter and the history.

3. The display apparatus according to claim 1, wherein the history with respect to the prechanged display parameter is displayed in the history window in time sequential order.

4. The display apparatus according to claim 1, wherein the history comprises at least one of a changed value and a change date.

5. The display apparatus according to claim 1, wherein the controller controls the display part to display a test window, on which the image is displayed according to the history corresponding to the display parameter stored in the memory, if the display parameter in the history window is selected.

6. The display apparatus according to claim 5, wherein the controller controls the memory to store the display parameter and the history corresponding to the display parameter if the controller determines that the test window is proper.

7. The display apparatus according to claim 1, wherein the user window generator further generates a menu window with respect to the plurality of display parameters which determine the display state of the image displayed in the display part, and wherein the menu window comprises a history selection item for displaying the history window.

8. The display apparatus according to claim 1, wherein the display parameter comprises at least one of a position parameter, a color temperature parameter, a resolution parameter, clock and phase parameters, a contrast parameter, a brightness parameter, and an audio parameter.

9. The display apparatus according to claim 1, wherein the user window generator comprises an OSD generator.

10. A control method of a display apparatus having a display part for receiving an image signal and displaying an image, comprising:
generating a history window comprising at least one display parameter for determining a display state of the image displayed in the display part according to a control signal and at least one history of a prechanged value corresponding to the display parameter;
displaying the image according to the history corresponding to the stored display parameter if at least one display parameter is selected in the history window;
displaying a test window on which the image is displayed according to the adjusted history;
determining a property of the test window to determine if the test window is proper; and
storing the display parameter and the history corresponding to the display parameter where the test window is proper.

11. The control method according to claim 10, wherein the history with respect to the prechanged display parameter is displayed in the history window in time sequential order.

12. A computer program embodied on a computer-readable medium for controlling a display apparatus having a display part for receiving an image signal and displaying an image, comprising:
a first set of instructions for generating a history window comprising at least one display parameter for determining a display state of the image displayed in the display part according to a control signal and at least one history of a prechanged value corresponding to the display parameter;
a second set of instructions for displaying the image according to the history corresponding to the stored display parameter if at least one display parameter is selected in the history window;
a third set of instruction for displaying a test window on which the image is displayed according to the adjusted history;
a fourth set of instructions for determining a property of the test window to determine if the test window is proper; and
a fifth set of instructions for storing the display parameter and the history corresponding to the display parameter where the test window is proper.
